(19) United States
(12) Patent Application Publication
(10) Pub. No.: US 2017/0068557 A1
(43) Pub. Date: Mar. 9, 2017

(54) OPERATION-SPECIFIC VIRTUAL MACHINE PLACEMENT CONSTRAINTS

(71) Applicant: International Business Machines Corporation, Armonk, NY (US)

(72) Inventors: Joseph W. Cropper, Rochester, MN (US); Jeffrey W. Tenner, Rochester, MN (US)

(21) Appl. No.: 15/050,799

(22) Filed: Feb. 23, 2016

Related U.S. Application Data
(63) Continuation of application No. 14/845,457, filed on Sep. 4, 2015.

(51) Int. Cl. G06F 9/455; H04L 29/08

(52) U.S. Cl. CPC G06F 9/45558; H04L 67/1004; G06F 2009/45595; G06F 2009/4557; G06F 2009/45583

(57) ABSTRACT

A cloud manager includes operation-specific placement constraints so a system administrator has more flexibility in placing virtual machines on physical hosts. The operation-specific placement constraints may include an override parameter that allows the placement constraints to be overridden by a system administrator. The placement constraints may include without limitation number of processors, amount of memory, affinity, anti-affinity and preferred host.

### BACKGROUND

1. Technical Field

This disclosure generally relates to virtual machines in a computing environment, and more specifically relates to placement of virtual machines on physical hosts in a computing environment.

2. Background Art

Cloud computing is a common expression for distributed computing over a network and can also be used with reference to network-based services such as Infrastructure as a Service (IaaS). IaaS is a cloud based service that provides physical processing resources to run virtual machines (VMs) as a guest for different customers. The virtual machine may host a user application or a server.

A computing environment, such as a cloud computing environment, may have a large number of physical machines that can each host one or more virtual machines. Prior art cloud management tools allow a system administrator to assist in determining a specific physical host in which to place or deploy a new virtual machine. After deployment, the cloud management tools may optimize the system by moving one or more virtual machines to a different physical host. The placement of the virtual machines may be determined by placement constraints.

### BRIEF SUMMARY

A cloud manager includes operation-specific placement constraints so a system administrator has more flexibility in placing virtual machines on physical hosts. The operation-specific placement constraints may include an override parameter that allows the placement constraints to be overridden by a system administrator. The placement constraints may include without limitation number of processors, amount of memory, affinity, anti-affinity and preferred host.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a cloud computing node;

FIG. 2 is a block diagram of a cloud computing environment;

FIG. 3 is a block diagram of abstraction model layers;

FIG. 4 is a block diagram showing a cloud manager that deploys virtual machines on computer resources;

FIG. 5 is table showing prior art placement constraints;

FIG. 6 is a table showing placement constraints defined for each VM operation type;

FIG. 7 is a flow diagram of a method for defining placement constraints for different VM operation types;

FIG. 8 is a flow diagram of a method for a cloud manager to place one or more VMs on physical hosts;

FIG. 9 is a table showing sample placement constraints for VM2 as known in the prior art;

FIG. 10 is a table showing sample placement constraints for VM2 that are mapped to VM operation type; and

FIG. 11 is a block diagram showing how a cloud manager could override the placement constrains for a VM recover operation to place VM2 on the same host as VM5.

### DETAILED DESCRIPTION

The disclosure and claims herein relate to a cloud manager that includes operation-specific placement constraints so a system administrator has more flexibility in placing virtual machines on physical hosts. The operation-specific placement constraints may include an override parameter that allows the placement constraints to be overridden by a system administrator. The placement constraints may include without limitation number of processors, amount of memory, affinity, anti-affinity and preferred host.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

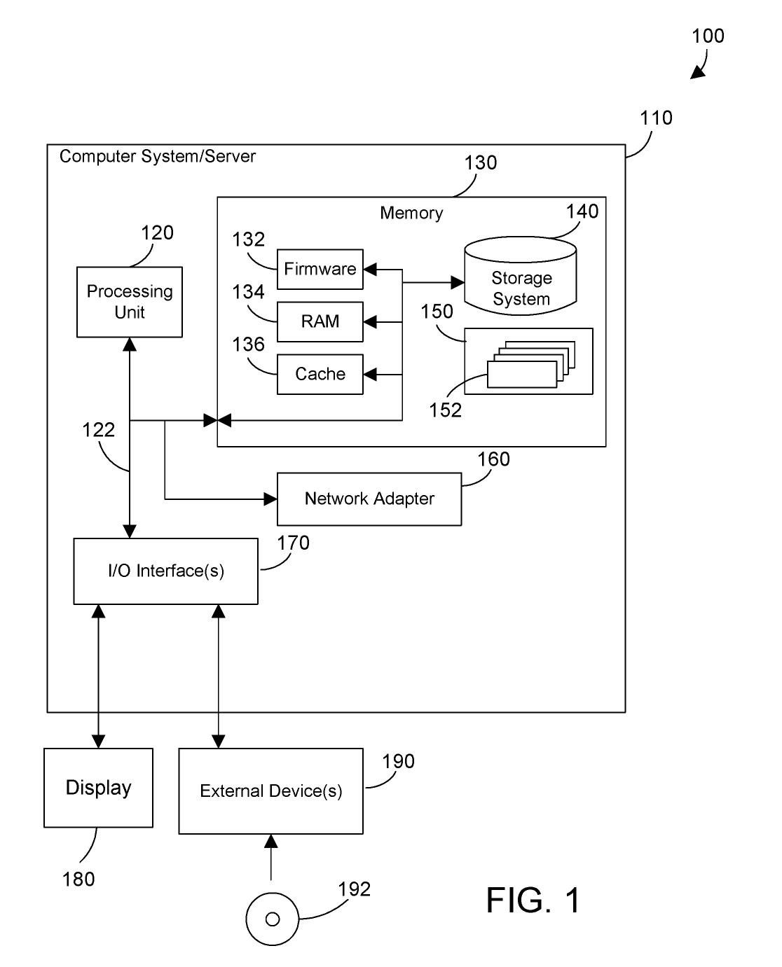

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processor 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media.

System memory 130 can include computer system readable media in the form of volatile, such as random access memory (RAM) 134, and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, RAID systems, tape drives, data archival storage systems, etc.

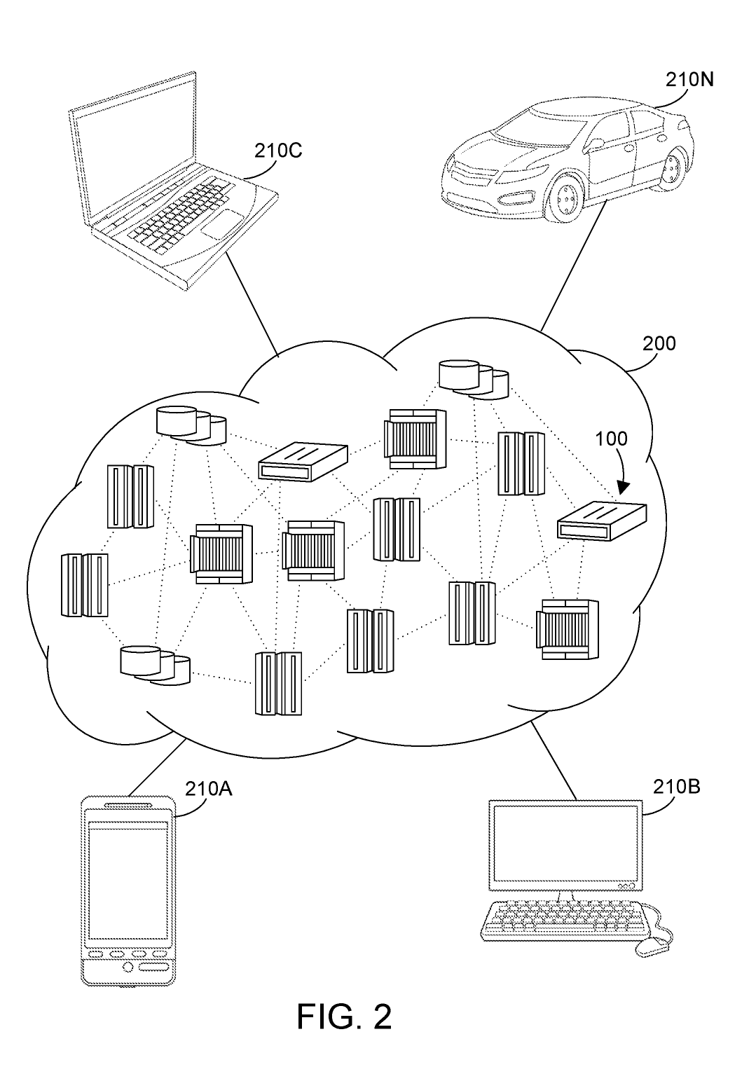

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

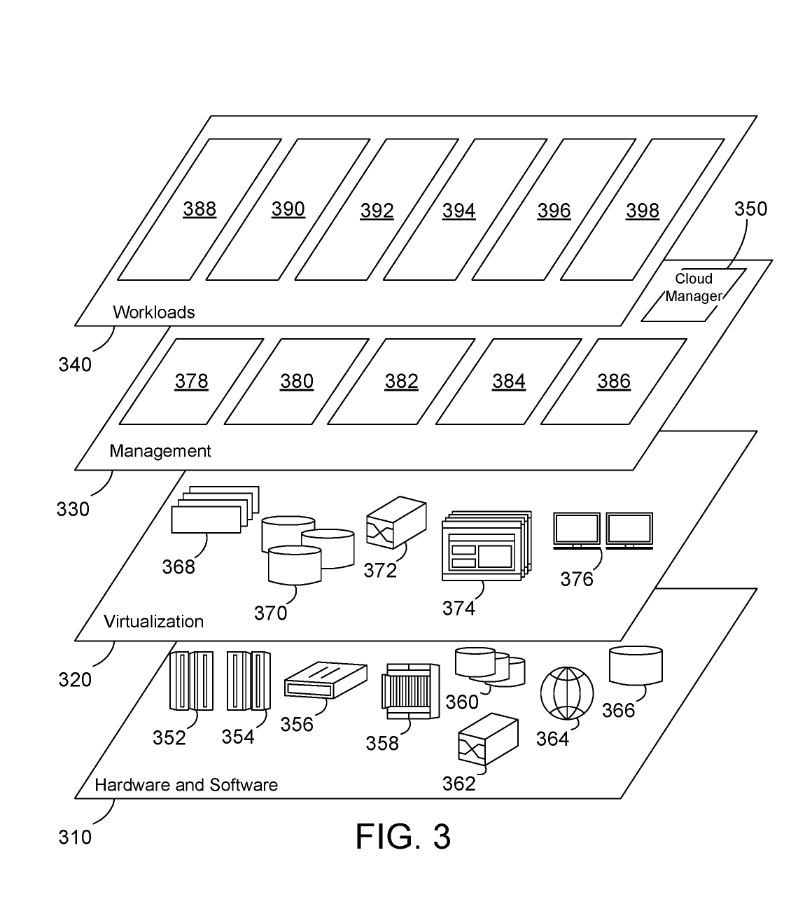

Referring now to FIG. 3, a set of functional abstraction layers provided by cloud computing environment 200 (FIG. 2) is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes 352; RISC (Reduced Instruction Set Computer) architecture based servers 354; servers 356; blade servers 358; storage devices 360; and networks and networking components 362. In some embodiments, software components include network application server software 364 and database software 366.

Virtualization layer 320 provides an abstraction layer from which the following examples of virtual entities may be provided: virtual servers 368; virtual storage 370; virtual networks 372, including virtual private networks; virtual applications and operating systems 374; and virtual clients 376.

In one example, management layer 330 may provide the functions described below. Resource provisioning 378 provides dynamic procurement of computing resources and other resources that are utilized to perform tasks within the cloud computing environment. Metering and Pricing 380 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 382 provides access to the cloud computing environment for consumers and system administrators. Service level management 384 provides cloud computing resource allocation and management such that required service levels are met. Service Level Agreement (SLA) planning and fulfillment 386 provide pre-arrangement for, and procurement of, cloud computing resources for which a future requirement is anticipated in accordance with an SLA. The management layer further includes a cloud manager 350 as described herein. While the cloud manager 350 is shown in FIG. 3 to reside in the management layer 330, the cloud manager 350 actually may span other levels shown in FIG. 3 as needed.

Workloads layer 340 provides examples of functionality for which the cloud computing environment may be utilized. Examples of workloads and functions which may be provided from this layer include: mapping and navigation 386; software development and lifecycle management 390; virtual classroom education delivery 392; data analytics processing 394; transaction processing 396 and mobile desktop 398.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

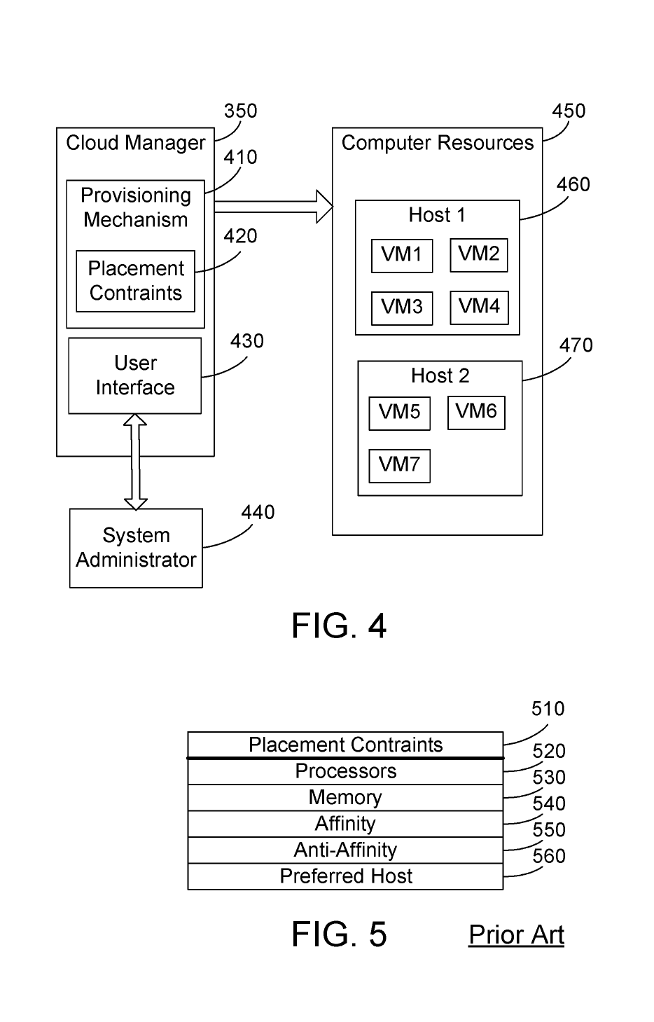

FIG. 4 shows one suitable example of a cloud manager 350. The cloud manager 350 could reside in the management layer 330 shown in FIG. 3, or could span multiple levels shown in FIG. 3. The cloud manager 350 includes a provisioning mechanism 410 that places virtual machines on computer resources 450 according to defined placement constraints 420. The cloud manager 350 could also be called a virtual machine manager because it manages the placement of virtual machines on computer resources. The placement constraints 420 may take any suitable form. In the most preferred implementation, the placement constraints 420 specify characteristics of a host computer system that must be met for a virtual machine to be placed on the host computer system. A user interface 430 allows a system administrator 440 to interact with the cloud manager to perform any suitable function, including provisioning of VMs, destruction of VMs, performance analysis of the cloud, etc. Of course, cloud manager 350 could include many other features and functions known in the art that are not shown in FIG. 4.

FIG. 4 shows an example that indicates how cloud manager 350 has deployed virtual machines to computer resources 450, which include for this example a first host computer system 460 and a second host computer system 470. Computer resources 450 could be physical computer systems in a cloud. In this example, the cloud manager 350 deployed VM1, VM2, VM3 and VM4 to the first host 460 and deployed VM5, VM6 and VM7 to the second host 470.

Referring to FIG. 5, prior art placement constraints 510 may include number of processors 520, amount of memory 530, affinity 540, anti-affinity 550, and preferred host 560. Number of processors 520 specifies a minimum number of processors that are needed by a virtual machine. Amount of memory 530 specifies a minimum amount of memory that is needed by a virtual machine. Affinity 540 indicates a preferred proximity to another virtual machine. Anti-affinity 550 indicates a preferred distance from another virtual machine, which means the two should not be deployed to the same host computer system. Preferred host 560 indicates a preferred host computer system for the virtual machine. Prior art cloud managers use the same placement constraints for all VM operations. Thus, if the placement constraints 510 are for VM2, and indicate an affinity for VM1 and an anti-affinity for VM5, these constraints are used for all VM operations for VM2, including deploy, suspend, resume, recover, resize, cold migration, and live migration. In prior art constraints 510, the cloud manager treats all constraints the same, meaning all must be satisfied, regardless of which VM operation is being performed.

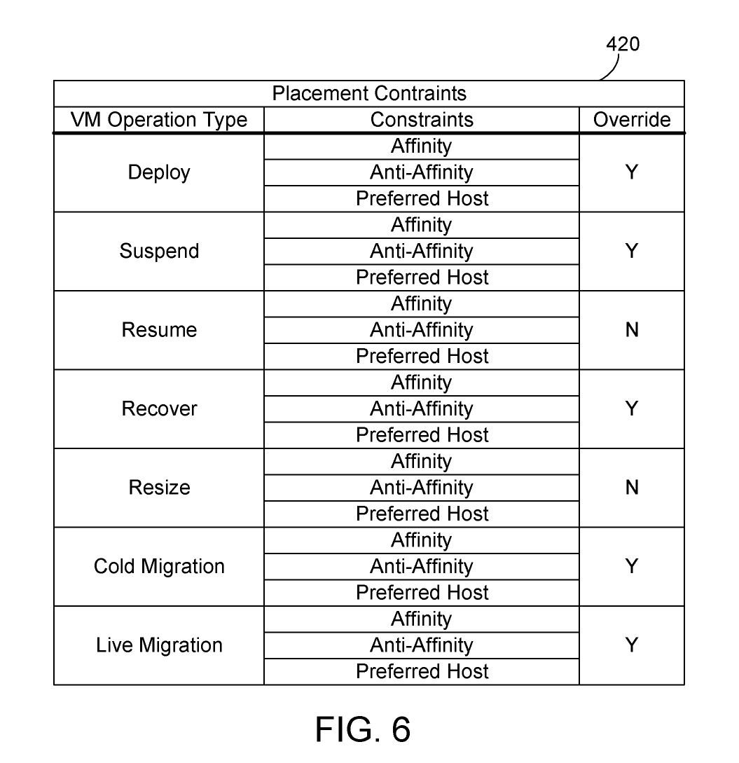

The disclosure and claims herein improve on the prior art by defining different placement constraints for different VM operations, as shown in FIG. 6. The placement constraints 420 recognize that some placement constraints are hard constraints that cannot be violated while other placement constraints are soft constraints that could be violated under some conditions. Examples of hard constraints are hardware constraints such as processors 520 and memory 530, as shown in FIG. 5. These are hard constraints because for a VM to run properly, it must have the minimum specified number of processors 520 and the minimum amount of memory 530. Soft constraints include affinity, anti-affinity and preferred host. These soft constraints can be independently defined for each VM operation type, as illustrated by the table in FIG. 6. While the hard constraints of processors and memory are not shown in FIG. 6, it is understood that these hard constraints are part of the constraints for each VM operation type. Placement constraints 420 additionally include an override parameter that, when set, allows the soft constraints to be overridden (i.e., ignored) for the specified VM operation type. For the example shown in FIG. 6, the Deploy operation may be overridden, along with Suspend, Recover, Cold Migration, and Live Migration, as indicated by the “Y” in the Override column. The Resume operation and the Resize operation have soft constraints that cannot be overridden (i.e., ignored) by the cloud manager.

The table in FIG. 6 is presented as one suitable way to map placement constraints to VM operation types. Of course, there are numerous other ways to map between the two. For example, in a different data structure, Affinity could be specified, and the VM operation types that include an Affinity placement constraint could be listed, such as Affinity[deploy, resize, live migration]. The disclosure and claims herein expressly extend to any suitable way to map between placement constraints and VM operation types, whether currently known or developed in the future.

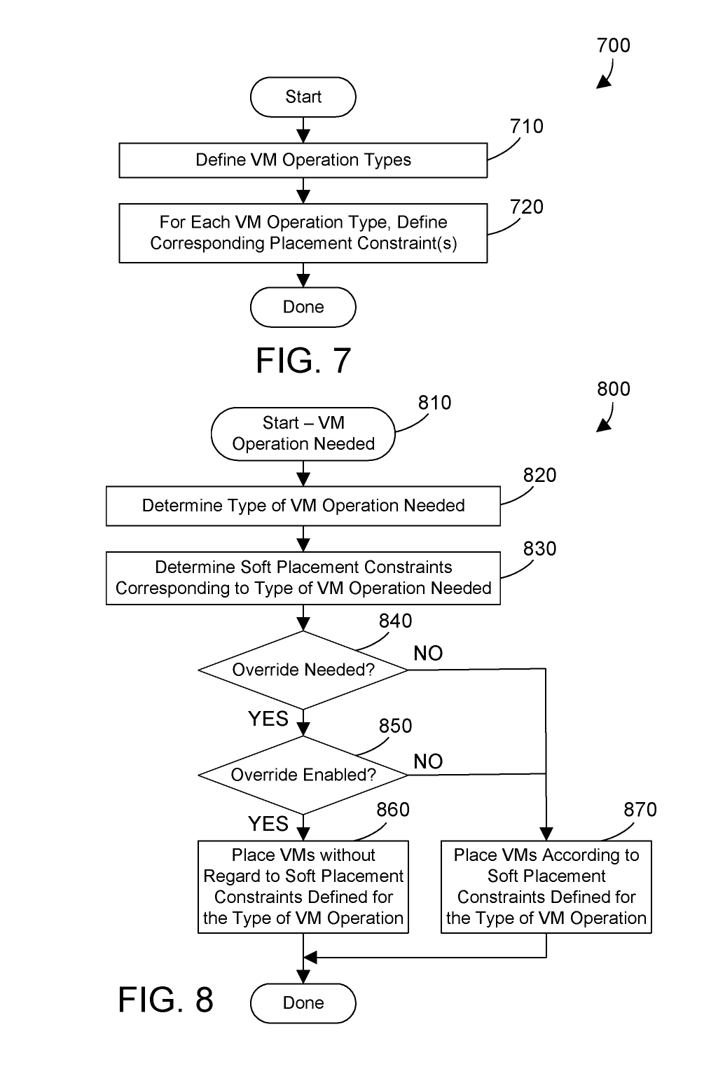

Referring to FIG. 7, a method 700 is preferably performed by the cloud manager 350 shown in FIGS. 3 and 4. VM operation types are defined (step 710). For each VM operation type, one or more corresponding placement constraints are defined (step 720). Note the defining of placement constraints in step 720 may include specifying whether the placement constraints can be overridden or not. By defining placement constraints for each VM operation type, the system administrator has much finer granularity and hence, much better control over the process of deploying VMs to computer resources.

Referring to FIG. 8, a method 800 begins when a VM operation is needed (step 810). Method 800 is preferably performed by the cloud manager 350 shown in FIGS. 3 and 4. The type of VM operation is determined (step 820). Soft placement constraints corresponding to the type of VM operation needed are determined (step 830). Note that hard placement constraints, such as the number of processors and amount of memory, must always be satisfied. When override is needed (step 840=YES), and override is enabled for the VM operation type (step 850=YES), VMs are placed by the cloud manager without regard to the soft placement constraints defined for the type of VM operation (step 860). An override could be needed, for example, when a system administrator wants to simply get a VM running on any host as soon as possible. Once running, the system administrator can take appropriate steps to migrate the VM to another host or perform other management functions, as needed, at which time the soft placement constraints can be taken into account. When override is not needed (step 840=NO), the VMs are placed by the cloud manager according to the soft placement constraints defined for the type of VM operation (step 870). When override is needed (step 840=YES) but override is not enabled (step 850=NO), the VMs are placed by the cloud manager according to the soft placement constraints defined for the type of VM operation (step 870). For the example in FIG. 6, override is enabled for those VM operations that have a “Y” in the Override column and is disabled for those VM operations that have an “N” in the Override column. Method 800 is then done.

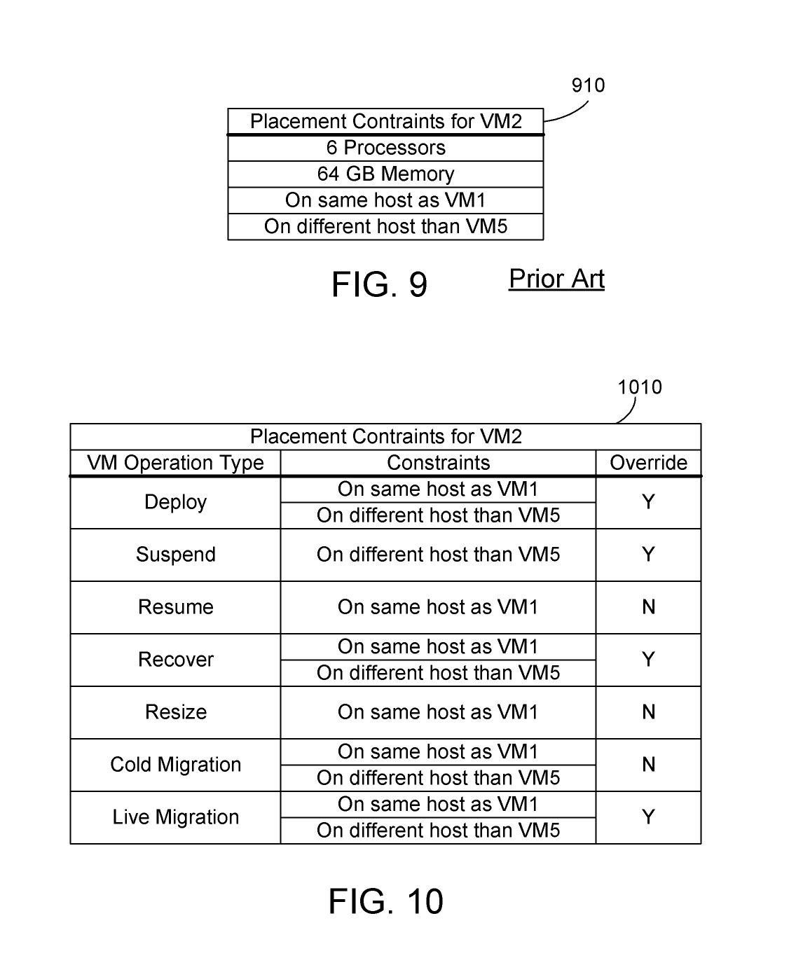

A simple example is now presented to illustrate some of the concepts discussed generally above. Placement constraints for VM2 910 shown in FIG. 9 are examples of prior art placement constraints, which specify a minimum of 6 processors, a minimum of 64 GB of memory, which specify an affinity for VM1 and an anti-affinity for VM5. Using these placement constraints, a prior art cloud manager could deploy VM2 to Host 1 460 as shown in FIG. 4, because host 460 hosts VM1, thereby satisfying the affinity constraint, while host 470 hosts VM5, thereby satisfying the anti-affinity constraint. Note the prior art placement constraints for VM2 910 shown in FIG. 9 are the same regardless of which VM operation type is being performed. The disclosure and claims improves on the prior art by allowing placement constraints to be defined for each VM operation type, as shown by placement constraints for VM2 1010 in FIG. 10. We assume there are hard placement constraints that cannot be violated, such as processors and memory. Because the hard placement constraints cannot be violated, it is assumed that each VM operation type includes these hard constraints, even though they are not explicitly shown in FIG. 10. For the specific example in FIG. 10, the VM operation types Deploy, Recover, Cold Migration and Live Migration have the same soft constraints, namely: on same host as VM1 and on different host than VM5. The soft constraints for Deploy, Recover and Live Migration can be overridden, as indicated by the Y in the Override column for these three operation types, but the soft constraints for Cold Migration cannot, as indicated by the N in the Override column for Cold Migration. Note also the soft constraints can differ from one operation to the next. Thus, Suspend has the anti-affinity constraint for VM5, but does not include the affinity constraint for VM1 that exists for the other six VM operation types. Note the soft constraints for Suspend can be overridden. The Resume and Resize VM operation types have the affinity constraint for VM1, but lack the anti-affinity constraint for VM5. The soft constraints for Resume and Resize cannot be overridden.

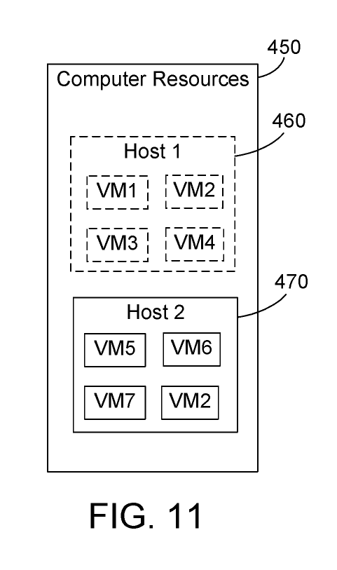

With the placement constraints 1010 shown in FIG. 10, we assume the cloud manager 350 initially places, or deploys, the VMs on the two hosts 460 and 470 as shown in FIG. 4. Note the soft constraints for the Deploy VM operation type in FIG. 10 have been satisfied, namely, the affinity of VM2 to VM1 has been satisfied by placing both on the same host 460, and the anti-affinity to VM5 has been satisfied by placing VM2 on a different host 460 that VM5, which is on host 470. Now we assume that Host 1 460 that hosts VM1, VM2, VM3 and VM4 has a catastrophic failure, causing VM1, VM2, VM3 and VM4 to stop working. This is illustrated in FIG. 11 by the host 460 and its four VMs being shown in dotted lines. Let's assume that VM2 is a critical virtual machine and has the highest priority of the four failed VMs. The system administrator's focus will be on getting VM2 up and running again as soon as possible, without regard to the placement constraints. Because the Recover VM operation type can be overridden, as shown in FIG. 10, the cloud manager can perform a recover operation for VM2 while overriding (i.e., ignoring) the soft constraints defined for the Recover VM operation type. Thus, while the anti-affinity with VM5 would normally cause VM2 to be deployed to a different host than VM5, in this case the system administrator can override the soft constraints and place VM2 on the same host 470 as VM5, as shown in FIG. 11. Of course, once VM2 is up and running again, and the system administrator has another host system available that can host VMs, the system administrator can perform live migration of VM2 or VM5 to a different host so the anti-affinity rule for VM2 will be satisfied. But in certain situations, the most important thing is bringing up a VM as quickly as possible. The ability to override the placement constraints provides the system administrator the ability to bring up a VM much more quickly without initially worrying about the placement constraints.

The disclosure and claims herein relate to a cloud manager that includes operation-specific placement constraints so a system administrator has more flexibility in placing virtual machines on physical hosts. The operation-specific placement constraints may include an override parameter that allows the placement constraints to be overridden by a system administrator. The placement constraints may include without limitation number of processors, amount of memory, affinity, anti-affinity and preferred host.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
at least one placement constraint defined for each of a plurality of virtual machine operation types, wherein a first of the plurality of virtual operation types has at least one placement constraint different than a second of the plurality of virtual operation types; and
a virtual machine manager residing in the memory and executed by the at least one processor, the virtual machine manager performing a selected virtual machine operation type while satisfying the at least one placement constraint corresponding to the selected virtual machine operation type.

2. The apparatus of claim 1 wherein the at least one placement constraint comprises an affinity to another virtual machine.

3. The apparatus of claim 1 wherein the at least one placement constraint comprises an anti-affinity to another virtual machine.

4. The apparatus of claim 1 wherein the at least one placement constraint comprises a preferred host.

5. The apparatus of claim 1 wherein the at least one placement constraint comprises hardware constraints that must be satisfied.

6. The apparatus of claim 5 wherein the hardware constraints comprise number of processors and amount of memory.

7. The apparatus of claim 1 wherein each placement constraint indicates whether the placement constraint can be overridden.

8. The apparatus of claim 7 wherein, when the placement constraint indicates the placement constraint can be overridden, the virtual machine manager performs the selected virtual machine operation type while not satisfying the at least one placement constraint corresponding to the selected virtual machine operation type.

9. The apparatus of claim 1 wherein the plurality of virtual machine operation types includes: deploy, suspend, resume, recover, resize, cold migration, and live migration.
